(19) United States
(12) Patent Application Publication
(10) Pub. No.: US 2025/0003432 A1
(43) Pub. Date: Jan. 2, 2025

(54) METHOD AND PROCEDURE FOR REMOTE MANAGEMENT OF A COMPRESSED AIR DISTRIBUTION SYSTEM

(71) Applicant: ATLAS COPCO AIRPOWER, NAAMLOZE VENNOOTSCHAP, Wilrijk (BE)

(72) Inventor: Wim PESSEMIER, Wilrijk (BE)

(73) Assignee: ATLAS COPCO AIRPOWER, NAAMLOZE VENNOOTSCHAP, Wilrijk (BE)

(21) Appl. No.: 18/706,673

(22) PCT Filed: Oct. 24, 2022
(86) PCT No.: PCT/EP2022/079621

§ 371 Date: May 1, 2024

(30) Foreign Application Priority Data
Nov. 8, 2021 (BE) BE2021/5867

(51) Int. Cl. F15B 21/08

(52) U.S. Cl. CPC F15B 21/087

(57) ABSTRACT

A computer-implemented method of remotely managing a compressed air distribution system by means of a control system of one or more compressors. The method is iteratively repeated, and includes the steps of sharing respective statuses by the one or more compressors with the control system via a shared communication bus, controlling the one or more compressors in parallel via the shared communication bus based on the statuses and on a required pressure and/or flow rate, and when a first device is connected to the compressed air distribution system, detecting the first device, integrating the first device. The integration is carried out simultaneously with the parallel control of the one or more compressors.

### TECHNICAL FIELD

The present invention is situated in the field of management and control of compressors in a compressed air distribution system via a control system, and more particularly in remotely conducting such management and control.

### STATE OF THE ART

It is known to use compressors to compress a gas in one or more stages. This compressed gas is supplied to one or more pneumatic consumers via a pneumatic network. The whole of compressors, consumers, and the conduits to connect these with each other is also called a compressed air distribution system.

The compressed air distribution system thus comprises one or more compressors for supplying a gas at a required pressure and/or flow rate to the pneumatic consumers. This required pressure and/or flow rate may vary over time, and is depending on various factors, such as the intended application, time of day, week, or year, and the like.

The term compressor further includes any other machine configured to produce compressed air, as well as vacuum.

To supply the gas at this required pressure and/or flow rate, a control system is used that controls and manages the compressors. The compressed air distribution system thus further comprises this control system. Controlling and managing compressors by the control system then means that the compressors can be switched on or off, and this at full load or partial load, depending on the capabilities of the compressors. To this end, the control system and the compressors exchange data, with which the control system can determine or directly measure the respective statuses of the compressors. Based on the statuses, in combination with the desired pressure and/or flow rate in the compressed air distribution system, the compressors are then controlled to match the supply of the compressors to the desired demand of the consumers.

For this control, the compressed air distribution system may further comprise sensors and/or other measuring devices which also exchange data with the control system.

Over time, the desired demand and/or the desired flow rate may have changed to such an extent that a change in the compressed air distribution system becomes necessary. This change then consists, for example, in the installation of an additional compressor in order to be able to meet an increasing demand and/or flow rate. On the other hand, the removal of a compressor can also be considered if it turns out that there is an overcapacity or that a replacement is necessary.

A modification of the compressed air distribution system may also occur when it is desired to optimize its control by, for example, installing new sensors and/or other measuring instruments, and/or changing the settings managed by the control system.

However, a disadvantage is that such changes to the compressed air distribution system imply an interruption of the optimum operation from the point of view of the consumers. Such interruption is undesirable for certain critical applications and should therefore be kept to a minimum.

Consequently, there is a need for a method and system to connect and/or disconnect a device to and/or to change the settings of a compressed air distribution system while minimizing any inconvenience to users of this system.

### SUMMARY OF THE INVENTION

It is an object of the present invention to provide a way to connect and/or disconnect a device to and/or to change the settings of a compressed air distribution system without interfering with the consumers already present in the system, or at the very least minimize the inconvenience.

This object is achieved, according to a first aspect of the invention, by providing a computer-implemented method for remotely managing a compressed air distribution system by means of a control system, wherein the compressed air distribution system is provided with one or more compressors, the method iteratively repeating, comprising the steps of:
sharing respective statuses by the one or more compressors with the control system via a shared communication bus;
controlling the one or more compressors in parallel by the control system via the shared communication bus based on the statuses and on a required pressure and/or flow rate; and
   when a first device is connected to the compressed air distribution system, wherein the device is capable of exchanging data:
detecting the first device via the shared communication bus;
integrating the first device into the control system for exchanging the data, wherein the integration is carried out simultaneously with the parallel control of the one or more compressors.

The compressed air distribution system comprises one or more compressors providing consumers with compressed air or other gases. This can be carried out by running the different compressors simultaneously, whereby each compressor can operate at full load or partial load. Thus, it should be further understood that the compressors can be controlled in such a way to meet the demand in terms of desired pressure and/or flow rate.

To ensure the proper operation, the compressors share their respective status with a control system. A status is then, for example, ‘running at full load’, ‘running at partial load’, ‘out of service’, or any other indication that is representative of the current operation of a respective compressor at that moment.

Status is further understood to mean the instantaneous settings of a respective compressor. This status, or these settings, can be read directly via the compressor, and/or via sensor values, derived values, alarms, or other relevant data indicative of a respective status.

The control system manages the compressors and, if necessary, will control them. Controlling therefore comprises switching on or off one or more compressors, or running one or more compressors at full or partial load, if they are suitable for this purpose.

Furthermore, the control system checks or monitors the demand side, wherein the control is subsequently adjusted to the desired demand.

Thus, by sharing the statuses and monitoring the demand side, the control system is able to control the demand side in terms of the required pressure and/or desired flow rate.

Controlling, monitoring and sharing of the statuses is carried out via a shared communication bus. Via this communication bus, data is exchanged between the compressors and the control system, as well as, if present, between other devices such as sensors and other measuring instruments. This data is exchanged via a communication protocol, such as, for example, UDP, TCP, CAN, Modbus TCP, Modbus RTU, LonWorks, SocketCAN, Mk5UDP, OPCUA, Profibus, Profinet, Ethernet/IP, EtherCAT, BACnet, MQTT, AMQP, or other wired or wireless communication standards.

Furthermore, the control system is controlled in a parallel manner. By this is meant that datagrams and/or data packets can be sent by the control system and/or the one or more compressors via the communication bus without there being a risk of coming into conflict with other datagrams and/or data packets. In other words, the communication between the control system on the one hand, and the one or more compressors and other optional devices present on the other hand, is carried out simultaneously.

Furthermore, it is not excluded that different communication protocols are used by the different devices present. In that case, a protocol conversion can then take place, if necessary.

Furthermore, an additional device can be added to the compressed air distribution system. Because a higher consumption is expected, this device can be, for example, an additional compressor to meet this changed user profile. Hence, from the point of view of the compressed air distribution system, this is a new device.

The additional or new device can also be a sensor to further optimize the control system and/or compressed air distribution system itself. Other examples of additional devices are a throttle valve, a dryer, a control valve, an energy recovery device, a pressure gauge, a flow meter, a temperature gauge, a compressed air consumer, or any other device that changes the configuration of the compressed air distribution system, or changes the way in which the control system can manage and/or control the compressed air distribution system.

According to an innovative element of the invention, this device is registered and integrated into the compressed air distribution system without interfering with the operation of the devices already present. In other words, the device can be added to the control system without shutting down the compressed air distribution system, or even part of it. The control system integrates the device to be able to exchange data, while simultaneously controlling the compressors. As a result, the inconvenience for the consumers already present in the compressed air distribution system is reduced to a minimum, or will be virtually zero.

By the integration of the device, data can be exchanged between the control system and the device to control the same, request measurements, or other actions for which the device is suitable and configurable.

When the device is linked to the compressed air distribution system, it is detected by the control system via the shared communication bus. It should therefore be understood that the device is suitable for exchanging data with the control system via the communication bus.

For exchanging data between the control system and the new device, if necessary, the communication protocol can be identified and if it is different from that of the control system, a protocol conversion can be applied. This allows the control system to communicate with the device.

After the device has been integrated into the control system, according to an embodiment of the invention, the device can be configured by the control system, wherein this step also occurs simultaneously with the parallel control of the one or more compressors. Configuring means that the device is set up in such a way that it has the desired functionality as a function of the control system and/or the compressed air distribution system. In other words, the setting parameters of the device can be adjusted and/or changed after it has been integrated into the compressed air distribution system.

On the other hand, according to an embodiment, the computer-implemented method further comprises the steps of, when a device is disconnected from the compressed air distribution system, detecting this disconnection, and, subsequently, removing the second device from the control system, wherein these steps are carried out simultaneously in parallel with the control of one or more compressors.

The device that is disconnected, can be a compressor, a sensor, or any other device that was initially connected to the compressed air distribution system and exchanged data with the control system.

Also when disconnecting, the inconvenience for the consumers already present will be reduced to a minimum, or will be virtually zero.

According to an embodiment, the detection of the connected and/or disconnected device can be initiated by the device itself. In the first case, this will happen after it is connected to the compressed air distribution system, and in the second case before it is disconnected. This will notify the control system directly by the device that there is a change in the compressed air distribution system.

According to a second aspect, the invention comprises a data processing system comprising a processor adapted to execute the method according to the first aspect of the invention.

According to a third aspect, the invention comprises a computer program product containing computer executable instructions for executing the method according to the first aspect when this program is executed on a computer.

According to a fourth aspect, the invention comprises a computer readable storage medium containing the computer program product according to the third aspect.

According to a fifth aspect, the invention comprises a compressor comprising the data processing system according to the second aspect.

### BRIEF DESCRIPTION OF THE DRAWINGS

The invention will now be further described with reference to the drawings in which:

FIG. 1 is a schematic representation of a control system for managing a compressed air distribution system;

FIG. 2 is a schematic representation of a step-by-step plan of a conventional intervention to reconfigure a machine;

FIG. 3 is a schematic representation of a step-by-step plan of an intervention according to an embodiment of the invention;

FIG. 4 is a schematic representation of a step-by-step plan of an intervention according to an embodiment of the invention in the presence of an incident.

### DESCRIPTION OF THE EMBODIMENTS

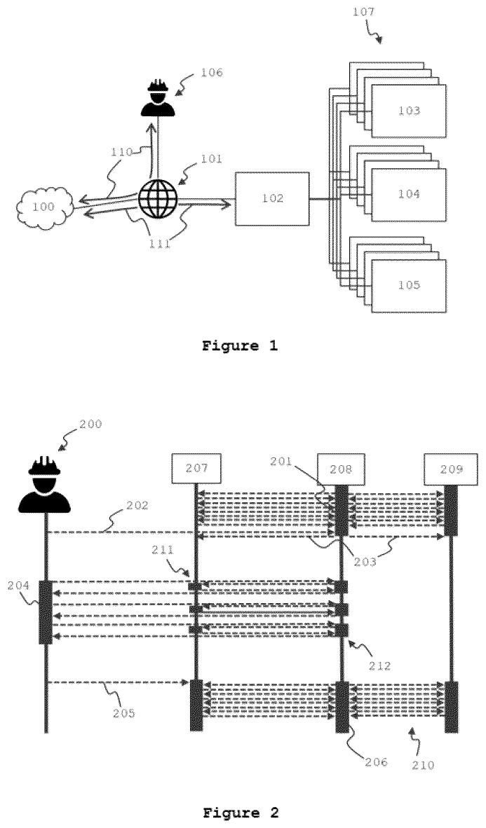

FIG. 1 illustrates a schematic representation of a control system for managing a compressed air distribution system 107. In this case, one or more machines can be managed, the machine being located in a compressed air distribution system 107. A machine is thus a compressor, a dryer, a control valve, sensors, or any other machine that can be present in a compressed air distribution system 107 and can be managed.

The central control system 102 is configured to make a connection 111 to a cloud application 100 over a network, such as, for example, the public internet 101. The initiation of the connection or connection 111 is carried out by an operator 106, wherein an instruction is directed to the cloud application 100 over the internet 101 and not directly to the control system 102 itself. This is illustrated by link or connection 110. The reason for this is because firewalls are more permissive to outgoing communications than to incoming communications.

Hence, the operator or technician 106 also connects 110 to the same cloud application 100 and, provided that the correct security information is presented, can establish the connection 111 between the two data streams, i.e. connection 110 and connection 111. This allows the technician 106 to manage and/or (re) configure the control system 102.

Management and/or (re) configuration is then further understood to mean that instructions can be given to the machines 103-105 in the compressed air distribution system 107. The machines are then, for example, compressors 103, dryers 104, and other machines such as sensors 105, that can be managed by the control system 102.

The technician 106 and the compressed air distribution system 107 can each be located in any location, independently of each other. The only condition is that they both have access to the internet 101.

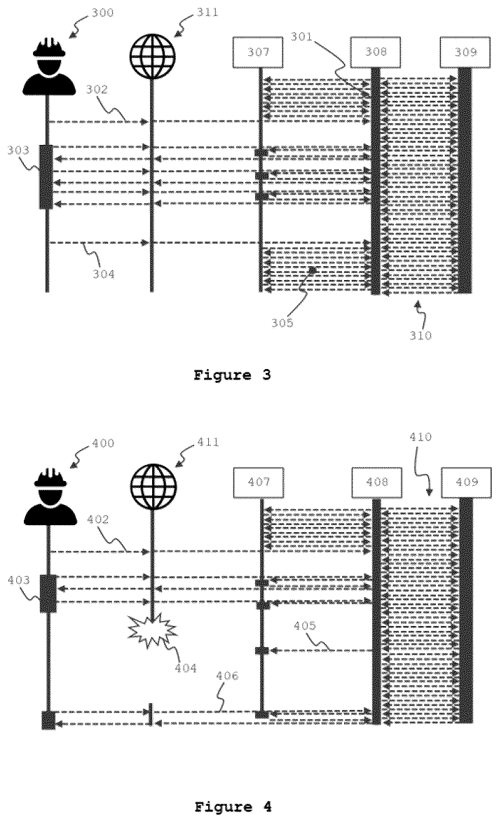

FIG. 2 illustrates a schematic representation of a step-by-step plan of a conventional intervention to reconfigure a machine 207 in a compressed air distribution system 107. In this case, a technician 200 will conduct an intervention on the machine 207 via a conventional central control system 208. The machine 207 is illustrative, for example, of a compressor. Furthermore, the compressed air distribution system 107 also houses other machines, illustrated by 209.

In FIGS. 2, 3, and 4, the dotted lines with arrows at the ends represent instructions given by a central operating system to respective machines, and status updates and/or acknowledgments from the machines back to the central operating system. The management by the central operating system and feedback from the machines by means of a status update and/or confirmation is further referred to as a feedback loop.

The central control system 208 controls the compressor 207 and the other machines 209 in a permanent or continuous feedback loop. This is further illustrated by control bus 201. When a technical intervention becomes necessary, for example to change the settings of the compressor 207 via the central control system 208 or via the machine 207 itself, the technician 200, via the central control system 208, will shut down the machine 207. operate. It is further to be understood that an intervention may also comprise an addition or disconnection of the machine 207 to the compressed air distribution system 107. This operation applies equally to all other machines 209 present in the compressed air distribution system 107. The instruction to stop all machines is illustrated by instruction 202. Subsequently, these machines will fall back on a local control, in other words, they will no longer be centrally controlled. This is illustrated by 203. Since these machines are no longer centrally controlled, the e of the compressed air distribution system 107 will therefore no longer operate optimally. After falling back to a local control, the settings can be changed locally, or optionally a reconfiguration can be carried out.

Subsequently, the technician 200 locally performs the interventions illustrated by the module 204 from which instructions can be given 211 to the machine 207 and locally 212 to the central control system 208.

After the settings of the machine 207 have been changed, or a reconfiguration has been made, the central control system 208 can again take control 205 of the compressed air distribution system 107, such that the feedback loop is operational again. The compressed air distribution system 107 is then again managed 206 by the central control system 208.

However, a problem with this conventional intervention is that the technician 200 must perform the intervention at the spot or on-site as there is continuously interaction. In addition, the other machines present will not operate optimally during the period of the intervention.

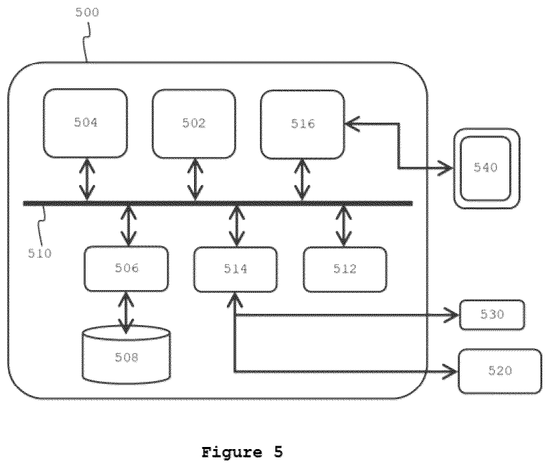

This problem is solved according to the method of the invention, further illustrated in FIG. 3 and FIG. 4. FIG. 3 illustrates a schematic representation of a step-by-step plan of an intervention according to an embodiment of the invention, and FIG. 4 illustrates a similar illustration in the presence of a incident.

Both in FIG. 3 and in FIG. 4, again a technician 300, 400, a machine 307, 407 on which an intervention is to take place, a central control system 308, 408, and other machines 309, 409 are present in the compressed air distribution system 107.

In the step-by-step plan as illustrated in FIG. 3, the technician 300 makes a connection with the compressed air distribution system 107, wherein an intervention on machine 307 has to be conducted. In contrast to the conventional strategy followed, as illustrated in FIG. 2, the tasks performed and instructions given by the central control system 308 are done in parallel. This is illustrated by control bus 301. In other words, while the intervention is conducted on machine 307, the other machines 309 remain under the management of the central control system 308, as further explained.

Because the tasks and instructions are executed respectively given in parallel, the technician 300 needs only to take the machine 307 out of the feedback loop, while the other machines 309 remain under the management of the central operating system 308.

The instruction 302 to take the machine 307 out of the feedback loop, can be carried out over the public internet 311. Subsequently, the machine 307 can be individually repaired, reconfigured, added and/or disconnected. This is illustrated by the local control bus 303.

After the repair and/or reconfiguration has been completed, the instruction 304 may be given to allow the machine 307 to be managed again or for the first time by the central control system 308, causing the entire compressed air distribution system 107 to operate optimally 305 again.

As illustrated by 210 and 310 respectively, it should be noted that in the conventional step-by-step plan, the feedback loop is temporarily suspended during the intervention, while according to the method of the invention, the feedback loop with the machines 309 continues to run. In other words, the other machines 309 have not been affected by the intervention on machine 307.

Finally, the method is further illustrated based on FIG. 4, in which an incident 404 occurs during an intervention.

The technician 400 again instructs 402, via the internet 411, to perform an intervention on machine 407. The management of the machine 407 is then taken over locally 403. Subsequently, the incident 404 comprises the loss of connection with the internet 411.

Although the machine 407 is no longer included in the feedback loop of the central control system 401, the compressed air distribution system 107 will continue to operate optimally as the other machines 409 are still managed 410 by the central control system 408.

According to an embodiment of the invention, the machine 407 can be brought into a safe state via the central control system 408. This is illustrated by instruction 405, given by the central control system 408 to machine 407.

The instruction 405 to put the machine 407 in a secure state, can be initiated autonomously by the central operating system 408 after, for example, a predefined period of time after the connection to the internet 411 has been lost 404. In that case, no interaction from the technician 400 is needed.

After the connection to the internet 411 is restored 406, the technician 400 can resume the technical intervention, again with no to minimal impact on the operational operation of the other machines 409.

FIG. 5 illustrates a computer system 500 for managing a compressed air distribution system 107. Computer system 500 may be generally configured as a suitable general purpose computer and comprise a bus 510, a processor 502, a local memory 504, one or more optional input interfaces 514, one or more optional output interfaces 516, a communication interface 512, a storage element interface 506, and one or more storage elements 508. Bus 510 may comprise one or more conductors that allow communication between the components of the computer system. Processor 502 may comprise any type of conventional processor or microprocessor that interprets and executes programming instructions. Local memory 504 may comprise a Random Access Memory (RAM) or any other type of dynamic storage device that stores information and instructions for execution by processor 502 and/or a Read-Only Memory (ROM) or any other type of static storage device that stores statistical information and instructions for use by processor 504. Input interface 514 may comprise one or more conventional mechanisms that allow an operator to input information into computer system 500, such as a keyboard 520, a mouse 530, a pen, voice recognition, and/or or biometric mechanisms, etc. Output interface 516 may comprise one or more conventional mechanisms that output information to the operator, such as a display 540. Communications interface 512 may comprise any send-and-receive mechanism such as two 1 Gb Ethernet interfaces that enable computer system 500 to communicate with other devices and/or systems, e.g. mechanisms to communicate with one or more other computer systems. The communication interface 512 of computer system 500 may be connected to such other computer system 560 by means of a LAN (local area network) or WAN (wide area network), such as the internet, in which case the other computer system may comprise, for example, a suitable web server. Storage element interface 506 may comprise a storage interface such as a SATA-interface (Serial Advanced Technology Attachment) or an SCSI (Small Computer System Interface) to connect bus 510 to one or more storage elements 508, such as one or more local drives, e.g. 1 TB SATA disk drives, and control the reading and writing of data to and/or from these storage elements 508. Although the storage elements 508 are described above as a local disk, generally any other computer readable media can be used, such as a removable magnetic disk, optical storage media such as a CD- or DVD-ROM, SSDs, flash memory cards, etc.

The present invention is by no means limited to the exemplary embodiments described and shown in the figures, but a compressor, user equipment and computer-implemented method according to the invention can be realized according to different variants without departing from the scope of the invention.

1-13. (canceled)

14. A computer-implemented method for remotely managing a compressed air distribution system by means of a control system, wherein the compressed air distribution system is provided with more than one compressors, the method iteratively repeating, comprising the steps of:
sharing respective statuses by the one or more compressors with the control system via a shared communication bus;
controlling more than one compressors in parallel by the control system via the shared communication bus based on the statuses and on a required pressure and/or flow rate; and
when a first device is connected to the compressed air distribution system, wherein the device is capable of exchanging data:
detecting the first device via the shared communication bus;
integrating the first device into the control system for exchanging the data, wherein the integration is carried out simultaneously with the parallel control of the one or more compressors;
configuring the first device via the control system after the integration, wherein the configuration is carried out simultaneously with the parallel control of one or more compressors.

15. The computer-implemented method according to claim 14, wherein the detection is initiated by the first device.

16. The computer-implemented method according to claim 14, wherein the step of integration further comprises:
identifying the communication protocol of the first device; and
when different from the communication protocol of the control system:
assigning a protocol conversion such that the control system can communicate with the first device.

17. The computer-implemented method according to claim 16, wherein the communication protocol of the first device and/or the control system comprises one communication protocol selected from the group consisting of: UDP, TCP, CAN, Modbus TCP, Modbus RTU, LonWorks, SocketCAN, Mk5UDP, OPCUA, Profinet, Profibus, Ethernet/IP, EtherCAT, BACnet, MQTT, and AMQP.

18. The computer-implemented method according to claim 14, wherein the first device comprises a compressor.

19. The computer-implemented method according to claim 14, the first device comprising a device selected from the group consisting of: a sensor, a valve, a dryer, an energy recovery device, a pressure gauge, a flow meter, and a temperature meter.

20. The computer-implemented method according to claim 14, further comprising the step of, when a second device is disconnected from the compressed air distribution system, wherein the second device is capable of exchanging data:
detecting the disconnection of the second device;
removing the second device from the control system, wherein the removal is carried out simultaneously with the parallel control of the one or more compressors.

21. The computer-implemented method according to claim 20, wherein the second device comprises a compressor of the one or more compressors.

22. A data processing system comprising a processor adapted to execute the method according to claim 14.

23. A compressor comprising the data processing system according to claim 22.
